(19) United States
(12) Patent Application Publication
(10) Pub. No.: US 2008/0083896 A1
(43) Pub. Date: Apr. 10, 2008

(54) Electromagnetic actuator

(75) Inventor: Jirou Kondoh, Kariya-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/905,714

(22) Filed: Oct. 3, 2007

(30) Foreign Application Priority Data
Oct. 6, 2006 (JP) 2006-275390
Mar. 12, 2007 (JP) 2007-062184

(51) Int. Cl. F16K 31/02

(52) U.S. Cl. 251/129.15

(57) ABSTRACT

A stator of an electromagnetic actuator and a sleeve of the spool valve are joined with the common secondary molding resin by molding. Since the spool valve and the electromagnetic actuator can be joined without using the caulking process, the relative position of the sleeve and the stator can be secured against an external force at the time of joint. Moreover, since the secondary molding resin 25 covers the outside surface of the stator, the outside surface of the stator is not exposed. Therefore, the process for acquiring the corrosion resistance of the stator becomes unnecessary.

### CROSS-REFERENCE TO RELATED APPLICATION

This application is based on Japanese Patent Applications No. 2006-275390 filed on Oct. 6, 2006 and No. 2007-62184 filed on Mar. 12, 2007, the disclosure of which is incorporated herein by reference.

### FIELD OF THE INVENTION

The present invention relates to an electromagnetic actuator. Especially, it relates to a joint structure of an actuation subject and an electromagnetism actuator.

### BACKGROUND OF THE INVENTION

An electromagnetic spool valve which drives the spool valve with an electromagnetic actuator is known. The spool valve is equipped with a cylindrical sleeve and a spool axially supported by the sleeve. The spool slides in the sleeve to change fluid passage, to adjust fluid flow rate, and to adjust fluid pressure.

The electromagnetic actuator includes a coil which generates a magnetic force by energization, a plunger driven by the magnetic force, and a stator which constitutes a magnetic circuit. The spool is driven with the magnetic driving force which acts on the plunger. The spool valve and the electromagnetic actuator are joined by caulking a part of stator on the sleeve. Specifically, as shown in JP-2003-90454A, the spool valve and the electromagnetic actuator are joined by caulking a caulking portion of a yoke on a flange portion of the sleeve.

In this caulking joint technique, a large mechanical force is applied to the caulking portion, the caulking portion is pressed on the flange, and the metallic caulking portion is plastic deformed. The flange portion also receives a pressing force from the caulking portion, and it is possible that a deformation will be arisen in the flange portion. When the deformation is arisen in the connecting portion, a relative position between the stator and the sleeve deviates from an appropriate position. As the result, the electromagnetic spool valve will have distortion, so that it becomes relatively difficult to assemble the electromagnetic spool valve.

Besides, in order to caulk the caulking portion on the flange, a caulking step is necessary, which increases manufacturing steps to increase manufacturing cost. Furthermore, since a part of stator, such as the yoke, is exposed to the atmosphere, it is necessary to perform coating for acquiring corrosion resistance. The productivity is deteriorated by the increase in the process number for acquiring this corrosion resistance, and it causes a cost rise.

Besides, the spool valve is disposed in an insert-hole of a cylinder head or a valve case in which a hydraulic circuit is formed. The electromagnetic actuator is disposed on the cylinder head. That is, the electromagnetic actuator is exposed to the atmosphere. Hence, the oil in the electromagnetic actuator is prevented from flowing out to the atmosphere.

In the conventional electromagnetic spool valve, there are provided a plurality of O-rings to seal clearances between the insert-hole and the sleeve, between the sleeve and the stator, and the like. Since there are a plurality of sealing portions in the conventional spool valve, a reliability to oil-leak is deteriorated, and the number of parts and manufacturing steps are increased to cause an increase in cost.

### SUMMARY OF THE INVENTION

The present invention is made in view of the above-mentioned matters. It is an object of the present invention to provide an electromagnetic actuator in which an actuation subject and the electromagnetic actuator are joined in high accuracy, and a corrosion resistance of the stator is enhanced.

In the electromagnetism actuator of this invention, the stator and the housing are joined with the molding resin. Thus, the actuation subject and the electromagnetic actuator can be joined, without using the caulking process. That is, the stator and the housing can be joined, without the plastic deformation of metal. Hence, a large external force causing a deformation does not act on a connecting portion of the housing and the stator, so that the relative position between the housing and the stator is kept appropriate and the distortion can be avoided.

Moreover, the molding resin which molds the stator covers an outer surface of the stator. Hence, the outer surface of the stator is not exposed to the atmosphere, and it is unnecessary to have another process for acquiring the corrosion resistance of the stator.

### BRIEF DESCRIPTION OF THE DRAWINGS

FIG. 1 is a cross-sectional view of an OCV along an axial direction.

FIG. 2 is a cross-sectional view of an electromagnetic actuator along the axial direction.

FIG. 3 is a cross-sectional view along the axial direction of the stator where the coil before the mould is performed by the secondary molding resin was incorporated.

FIG. 4 is a cross-sectional view of a front stator along the axial direction, in which a coil is incorporated.

FIG. 5A is a front view of the front stator, and FIG. 5B is a cross-sectional view of the front stator along the axial direction.

FIG. 6 is a schematic diagram of a VVT.

FIG. 7 is a sectional view of the OCV along the axial direction according to a second embodiment.

FIG. 8 is a cross-sectional view of the OCV according to the second embodiment.

FIG. 9 is a cross-sectional view of an essential part of the OCV according to the second embodiment.

FIG. 10 is a cross-sectional view of an essential part of the OCV according to a third embodiment.

FIG. 11 is a cross-sectional view of an essential part of the OCV according to a fourth embodiment.

### DETAILED DESCRIPTION OF THE PREFERRED EMBODIMENTS

An electromagnetic actuator drives the spool (an actuation subject) arranged in the sleeve (a housing) of the spool valve (an actuation subject device).

### First Embodiment

Referring to drawings, a first embodiment in which an electromagnetic actuator of the present invention is applied to the oil flow control valve (OCV, hereinafter) in a valve timing controller (VVT, hereinafter) will be described.

### (Structure of VVT)

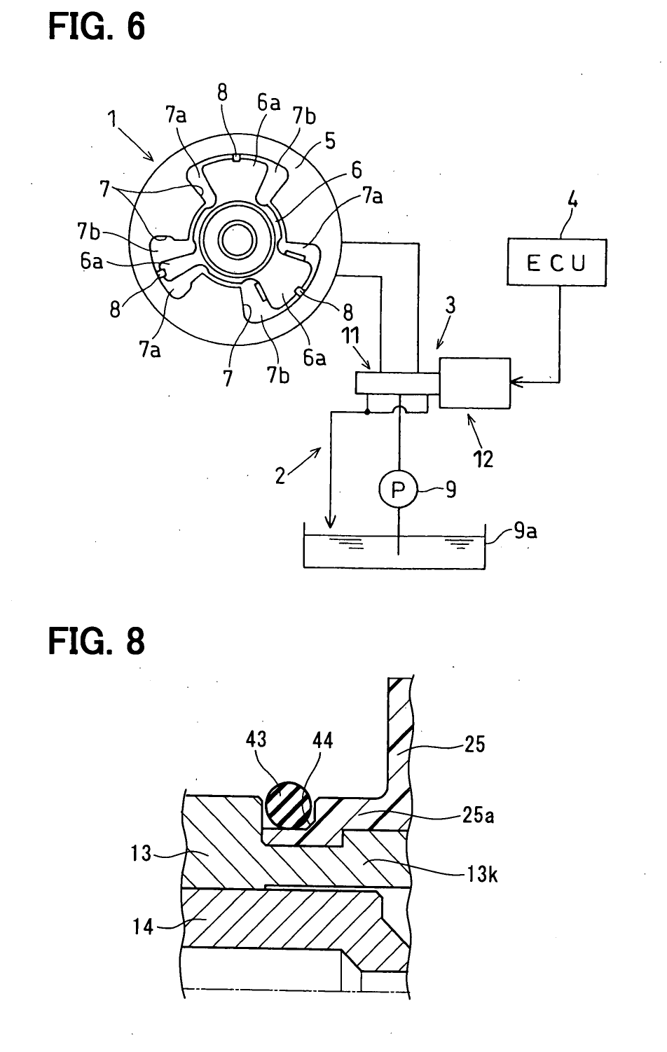

Referring to FIG. 6, a structure of VVT is schematically explained. The VVT includes a variable valve timing mechanism 1 (VCT 1, hereinafter), a hydraulic circuit 2 which performs oil pressure control of the actuation of the VCT 1, and an ECU 4 (Engine Control Unit) which electrically controls the OCV 3 provided in the hydraulic circuit 2. The VCT 1 is provided to a camshaft (intake valve camshaft, exhaust valve camshaft, or intake/exhaust valve camshaft) of an internal combustion engine, and adjusts its valve timing continuously.

### (Structure of VCT1)

The VCT1 is provided with a shoe housing 5 which is rotated along with a crankshaft of the engine, and is provided with a vane rotor 6 which is relatively rotated to the shoe housing 5 and is rotated along with the camshaft. The vane rotor 6 is rotated relative to the shoe housing 5 by a hydraulic actuator provided in the shoe housing 6, so that the camshaft is advanced or retarded.

The shoe housing 5 is connected to the sprocket (not shown) by a bolt, and rotates with the sprocket. The sprocket is rotated by the crankshaft through a timing belt or a timing chain. Inside the shoe housing 5, as shown in FIG. 6, a plurality of fan-shaped concave portions 7 are defined. In this embodiment, three concave portions 7 are formed. In addition, the shoe housing 5 rotates clockwise in FIG. 6, and this rotative direction is an advance direction. On the other hand, the vane rotor 6 is positioned with a centering pin at the edge of a camshaft, and is fixed to the edge of a camshaft by a bolt.

The vane rotor 6 is equipped with the vane 6a which divides the inside of the concave portion 7 of shoe housing 5 into an advance chamber 7a and a retard chamber 7b. The vane rotor 6 is rotatable within the predetermined angle relative to the shoe housing 5. The advance chamber 7a is an oil pressure chamber for driving the vane 6a in the advance direction with an oil pressure. The retard chamber 7b is an oil pressure chamber for driving the vane 6a in the retard direction with an oil pressure. In addition, the fluid-tight in each chamber 7a and 7b is maintained by seal member 8.

### (Structure of the Hydraulic Circuit 2)

In order to perform the feeding and discarding of the oil to the advance chamber 7a and the retard chamber 7b, and to perform relative rotation of the vane rotor 6 to shoe housing 5, the hydraulic circuit 2 has an oil pump 9 driven by the crankshaft, and the OCV3 which distribute the oil (oil pressure) to the advance chamber 7a or the retard chamber 7b, and make a differential oil-pressure between the advance chamber 7a and the retard chamber 7b.

### (Structure of the OCV3)

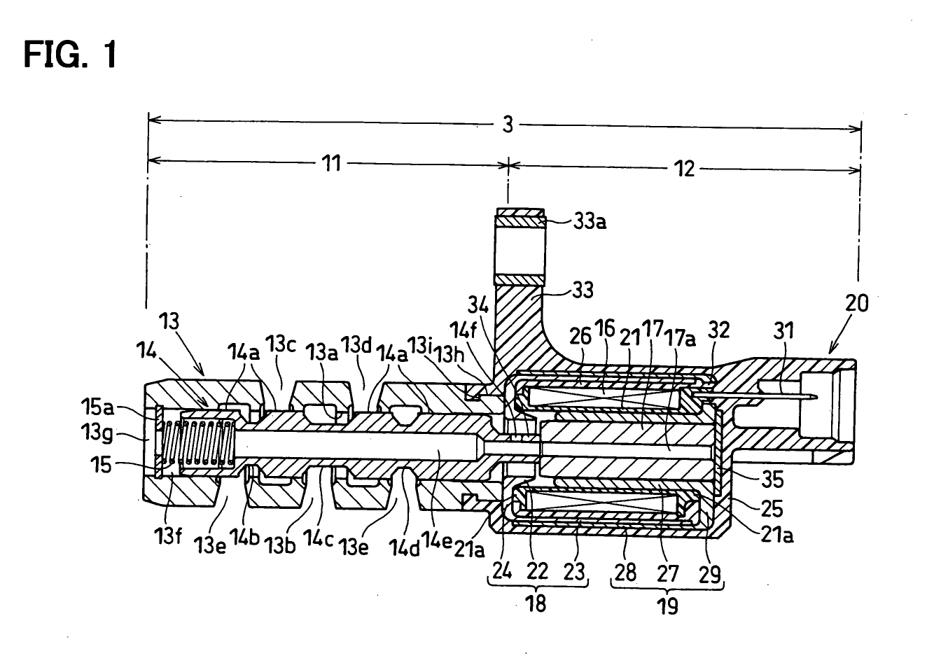

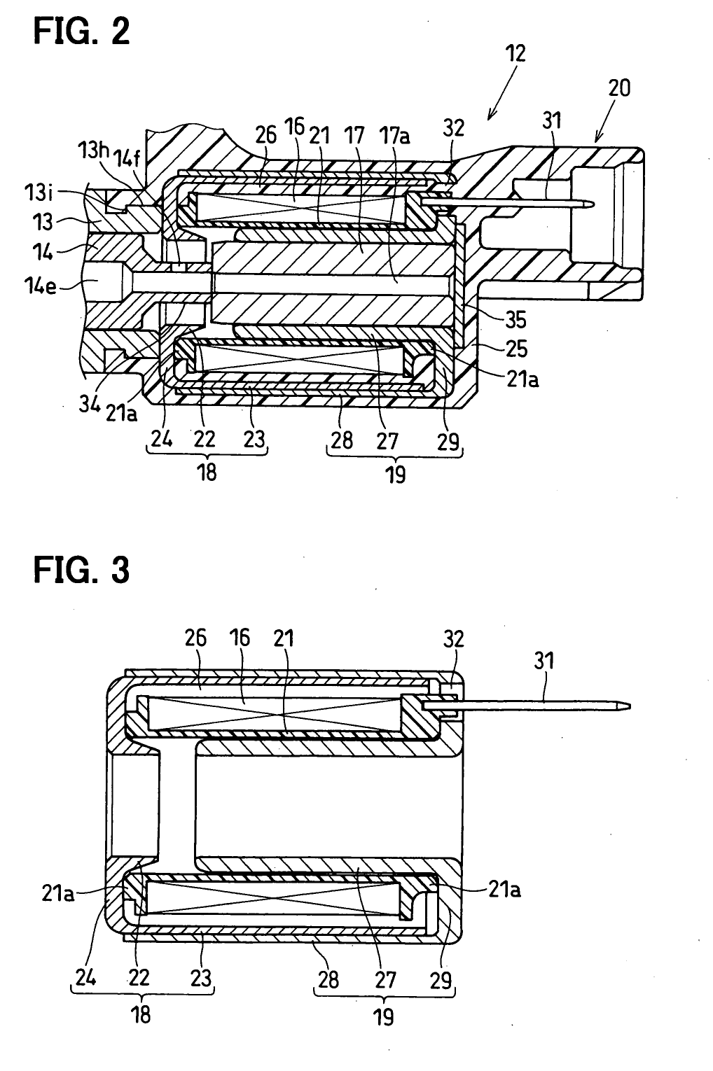

Referring to FIGS. 1 and 2, a structure of the OCV3 will be described. The OCV 3 is an electromagnetic spool valve including a spool valve 11 and an electromagnetic actuator 12. The spool valve 11 includes a sleeve 13, a spool 14, and a return-spring 15. The sleeve 13 is substantially cylindrical and is provided with a plurality of input ports and output ports. Specifically, the sleeve 13 is provided with an insert hole 13a in which the spool 14 slides in the axial direction, a hydraulic-pressure supply port 13b which communicates with an outlet port of the oil pump 9, an advance port 13c which communicates with the advance chamber 7a, a retard port 13d which communicates with the retard chamber 7b, and a drain port 13e for returning the oil to an oil pan 9a.

The drain port 13e, the advance port 13c, the hydraulic-pressure supply port 13b, the retard port 13d, and the drain port 13e are formed at side surface of the sleeve 13 in this series from left to right in FIG. 1.

The spool 14 has four large-diameter portion 14a of which outer diameter is substantially equal to an inner diameter of the sleeve 13 (diameter of the insert hole 13a). Between each of the large-diameter portions 14a, the spool 14 has a small-diameter portion 14b for draining the advance chamber, a small-diameter portion 14c for supplying hydraulic pressure, and a small-diameter portion 14d for draining the retard chamber. The small diameter 14b is for draining the hydraulic pressure in the advance chamber 7a when the hydraulic pressure is supplied to the retard chamber 7b. The small diameter 14c is for distributing hydraulic pressure into one of the advance chamber 7a and the retard chamber 7b. The small diameter 14a is for draining the hydraulic pressure in the retard chamber 7b.

The return spring 15 is disposed in a spring chamber 13f and one end of the return spring 15 is engaged with stopper plate 15a. The return spring 15 biases the spool 13 toward right direction in FIG. 1. The stopper plate 15a is provided with a hole for breathing.

### (Structure of the Electromagnetic Actuator 12)

The electromagnetic actuator 12 is provided with a coil 16, a plunger 17, a stator (a front stator 18, a rear stator 19), and a connector 20. The coil 16 is wound around a bobbin 21, and generates a magnetic force to attract the plunger 17 toward the magnetic attracting portion 22

The bobbin 21 has a cylindrical portion around which the coil 16 is wound and flanges at both ends of the cylindrical portion to hold edges of the coil 16. The bobbin 21 is made of primary molding resin. That is, the bobbin 21 is made by pouring melted resin (for example, PBT) into a molding die for bobbin 21. The bobbin 21 has substantially cylindrical boss portions 21a at both ends thereof. The boss portions 21a are located inside periphery of the flanges.

The plunger 17 is a cylindrical column made from magnetic metal (for example, iron) which is attracted by the magnetic attracting portion 22. The plunger 17 slides on an inner surface of a magnetically transmitting portion 27.

Referring to FIGS. 1 to 5, the stator is described hereinafter. In FIGS. 1 to 4 and 5B, left side is defined as front side, and right side is defined as rear side. The stator accommodates the coil 16 and forms a closed magnetic path around the coil 16. The stator includes the magnetic attracting portion 22 which attracts the plunger 17 in the axial direction, a yoke (a first yoke 23, and a second yoke 28) surrounding the coil 16, and the magnetically transmitting portion 27 which radially transmits a magnetic flux to the plunger 17. The stator is structured by combining a plurality of units in order to dispose the coil 16 therein. In this embodiment, the stator is comprised of a front stator (a first stator) 18 and a rear stator (a second stator) 19.

The front stator 18 is comprised of the magnetic attracting portion 22 which attracts the plunger 17 to left side, the first yoke 23 surrounding the coil 16, and a front ring flange 24 which connects the magnetic attracting portion 22 and the first yoke 23. The front stator 18 is made of magnetic material (for example, iron).

The magnetic attracting portion 22 generates a magnetic flux at a left end of the plunger 17. The magnetic attracting portion 22 is substantially cylindrical so that a part of plunger 17 is able to cross the magnetic attracting portion 22 in the axial direction without being in contact with each other. An outer periphery of the magnetic attracting portion 22 is tapered, and the magnetic attracting force is constant without respect to stroke amount of the plunger 17. In this embodiment, the outer periphery of the plunger 17 is tapered. Alternatively, an inner periphery of the magnetic attracting portion 22 can be tapered.

The first yoke 23 is combined with the second yoke 28 to form the yoke. The first yoke 23 is substantially cylindrical and its inner diameter is slightly larger than an outer diameter of the bobbin 21. A gap clearance between the first yoke 23, the coil 16, and the bobbin 21 is filled with a secondary molding resin 25. That is, a filling space 26 is formed between the first yoke 23 and the coil 16 (including the bobbin 21) into which the secondary molding resin 25 is introduced. The first yoke 23 overlaps the coil 16 in a whole axial length. A rear end of the first yoke 23 (right end in FIG. 3) extends over a rear end of the coil 16.

The front ring flange 24 is a ring plate which connects the magnetic attracting portion 22 and the first yoke 23. The front ring flange 24 is provided with a plurality of through holes 24a at a portion confronting the filling space 26, not the boss portions 21a.

The rear stator 19 is comprised of the magnetically transmitting portion 27 which covers the plunger 17 and radially transmits/receives the magnetic flux from the plunger 17. Furthermore, the rear stator 19 is comprised of the second yoke 28 surrounding the coil 16, and a rear ring flange 29 which connects the magnetic attracting portion 27 and the second yoke 28. The rear stator 19 is made of magnetic metal, such as iron.

The magnetically transmitting portion 27 is cylindrical to cover the outer periphery of the plunger 17. The inner surface of the magnetically transmitting portion 27 slidably supports the plunger 17 in the axial direction, and the magnetic flux is transmitted between the plunger 17 and the magnetically transmitting portion 27. The second yoke 28 is cylindrical as well as the first yoke 23. The second yoke 28 covers the outer surface of the first yoke 23 and is magnetically connected thereto. The overlapping between the first yoke 23 and the second yoke 28 extends along an axial line.

An inner diameter of the second yoke 28 is almost the same as the outer diameter of the first yoke 23. The second yoke 28 is fitted into the first yoke 23, or assembled to the first yoke 23 through a clearance. The second yoke 28 overlaps the coil in a whole axial length. That is, a front end of the second yoke 28 (left end in FIG. 3) extends over a front end of the coil 16.

The rear ring flange 29 is a ring plate which connects the magnetically transmitting portion 27 and the second yoke 28. The rear ring flange 29 is provided with a terminal hole 32 through which two terminals 31 extends, at a portion confronting the filling space 26, not the boss portions 21a. The coil 16 is energized through the terminals 31. The terminal hole 32 functions as a resin introducing hole for introducing the secondary molding resin into the filling space 26.

A connector 20 is made of the secondary molding resin 25 which molds the coil 16. The terminals 31 connected to the coil 16 are provided in the connector 20. One end of the terminal 31 is exposed within the connector 20, and the other end is molded in the secondary molding resin 25 in a such a manner as to be inserted into an insert attaching part 21b formed in the bobbin 21.

The secondary molding resin 25 in the filling space 26 has a function for fixing the coil 16, a function for forming the connector 20, a function for forming a housing of the electromagnetic actuator 12, a function for connecting the spool valve 11 and the electromagnetic actuator 12, and a function of bracket 33 for fixing the OCV 3 on an engine head. After providing parts of the actuator 12 in a molding die, melted secondary molding resin 25, such as PBT, is injected into the molding die. The bracket 33 is provided with a metal sleeve 33a for receiving a fastening force from a bolt (not shown).

The OCV 3 includes a shaft 34 which transfers a driving force of the plunger 17 to the spool 14 and transfers a biasing force of the return spring 15 to the plunger 17. In this embodiment, the shaft 34 is integrated with the spool 14. Alternatively, the shaft 34 can be made as a separate body from the spool 14. The shaft 34 and the spool 14 have a spool passage 14e therein. The plunger 17 has a plunger passage 17a therein. The spool passage 14e and the plunger passage 17a are in communication with each other, so that a volume changing part at right side of the plunger 17 communicates with the drain port 13g. Besides, the shaft 34 has a breathing port 14f which communicates a chamber around the shaft 34 and the spool passage 14e.

Next, a method of forming the housing of the electromagnetic actuator 12 and connecting the OCV 3 and the electromagnetic actuator 12 by the secondary molding resin 25 will be described in detail. The secondary molding resin 25 covers the stator and fixes the stator. Furthermore, the secondary molding resin 25 covers an end portion of the sleeve 13, which is close to the electromagnetic actuator 12. The secondary molding resin 25 connecting the OCV 3 and the electromagnetic actuator 12 is the same as the resin material which molds the coil 16 and forms the connector 20 and the bracket 33.

In order to combine the OCV 3 and the electromagnetic actuator 12 by the secondary molding resin 25, the following structures are employed in the first embodiment.

(1) Robust improving means for improving strength of the secondary molding resin 25 which connects the sleeve 13 and the stator.

(2) Stopper means for preventing the sleeve 13 from being pulled out from the secondary molding resin 25.

(3) Sleeve seal means for preventing the melted secondary molding resin 25 from flowing into the interior of the sleeve 13 and the stator through a clearance gap therebetween.

(4) End seal means for preventing the melted secondary molding resin 25 from flowing into the interior of the magnetically transmitting portion 27 (that is, the sliding surface of the plunger 17).

(5) Stator seal means for preventing the melted secondary molding resin from flowing into the interior of the bobbin 21 through a clearance gap between the stator and the bobbin 21.

The robust improving means will be described hereinafter. The robust improving means improves the connecting strength of the secondary molding resin 25 between outside of the stator and the interior of the filling space 26 so that the connecting strength of the sleeve 13 and the stator is improved. Specifically, the front ring flange 24 includes a plurality of through holes 24a through which melted resin material flows at a place confronting the filling space 26. As shown in FIGS. 5A and 5B, a plurality of the through holes 24a are circumferentially provided at the same interval at the front ring flange 24. A part of the secondary molding resin 25 in the filling space 26 flows into the outside of the sleeve 13 through the through holes 24a. Alternatively, a part of the resin material 25 in the outside of the sleeve 13 flows into the filling space 26 through the through hole 24a. Thereby, at molding, the melted resin material introduced to the sleeve 13 through the filling space 26 and the melted resin material introduced to the sleeve 13 through the outer periphery of the stator merge on the sleeve 13. The secondary molding resin 25 outside of the stator and inside of the stator merge on the sleeve 13. The strength of the secondary molding resin 25 which connects the sleeve 13 and the stator is improved.

Next, the stopper means will be described hereinafter. The stopper means prevents the sleeve 13 from being pulled out from the secondary molding resin 25 even if an outer force is applied to the sleeve 13. The sleeve 13 is substantially cylindrical and a molding portion by the secondary molding resin 25 is also cylindrical. A cylindrical end portion 13h which is molded by the secondary molding resin 25 has a smaller diameter than the outer diameter of the sleeve 13. As shown in FIGS. 1 and 2, the cylindrical end portion 13h has a step portion 13i. Specifically, the end portion 13h has an annular groove at the front side, and a rear wall of the groove forms the step 13i. The secondary molding resin 25 covering the end portion 13h is engaged with the step 13i, so that the sleeve 13 is hardly pulled out from the secondary molding resin 25 even if large outer force is applied to the sleeve 13.

Next, the sleeve seal means will be described hereinafter. The rear end of the sleeve 13 is brought into contact with the magnetic attracting portion 22, whereby the sleeve seal means prevents the melted resin from flowing into the interior of the sleeve 13 through a clearance gap between the sleeve 13 and the stator. Specifically, while the rear end face (contact surface with the stator) of a sleeve 13 is formed as a vertical and smooth flat surface relative to the axial direction, the front face (contact surface with a sleeve 13) of the front ring flange 24 is also formed as a vertical and smooth flat surface relative to the axial direction. And the sleeve 13 and the stator are pressurized in the axial direction at the time of molding the secondary molding resin 25, so that the contacting surfaces are firmly contacted to each other. Hence, the melted resin material does not leak to the inner circumference side, and no resin material adheres to the sliding surface of the spool 14 and the plunger 17.

Next, the end seal means will be described hereinafter. The end seal means blockades the opening periphery of the magnetically transmitting portion 27 with a stopper 35 which is made of nonmagnetic metal. The end seal means prevents the melted resin from flowing into the interior of the magnetically transmitting portion 27 at the time of molding the secondary molding resin 25. Specifically, the stopper 35 is a flat disc which is made of non-magnetic metal, such as copper, brass, aluminum, and stainless steel, and the contact surface with the stator, at least, is a smooth flat surface. Moreover, the rear face (contact surface with a stopper 35) of the rear ring flange 29 is also formed as the vertical and smooth flat surface relative to the axial direction. And a stopper 35 and a stator are pressurized in the axial direction at the time of molding the secondary molding resin 25, the contacting surfaces are firmly in contact with each other. Hence, the melted resin does not leak to the inner circumference, and no molding resin adheres to the sliding surface of a plunger 17. Moreover, since a plunger 17 contacts the metal stoppers 35 at the time of deenergizing the coil 16, there is no resin abrasion at the stopper surface of the plunger 17. Furthermore, since a stopper 35 is a non-magnetic material, there is no fault in which the plunger 17 performs magnetic adhesion at a stopper 35.

Next, a stator seal means will be described hereinafter. The stator seal means prevents the melted resin from flowing into the interior of the bobbin 21 through a clearance gap between the bobbin 21 and the stator by bringing the front end and rear end of the bobbin 21 into contact with the stator. Specifically, the boss portion 21a of a bobbin 21 has a vertical and smooth flat surface in the head side (contact surface with a stator) in the axial direction. The rear face (contact surface with the boss section 21a) of the front ring flange 24 and the front face (contact surface with the boss section 21a) of the rear ring flange part 29 are also formed as the vertical and smooth flat surface relative to the axial direction.

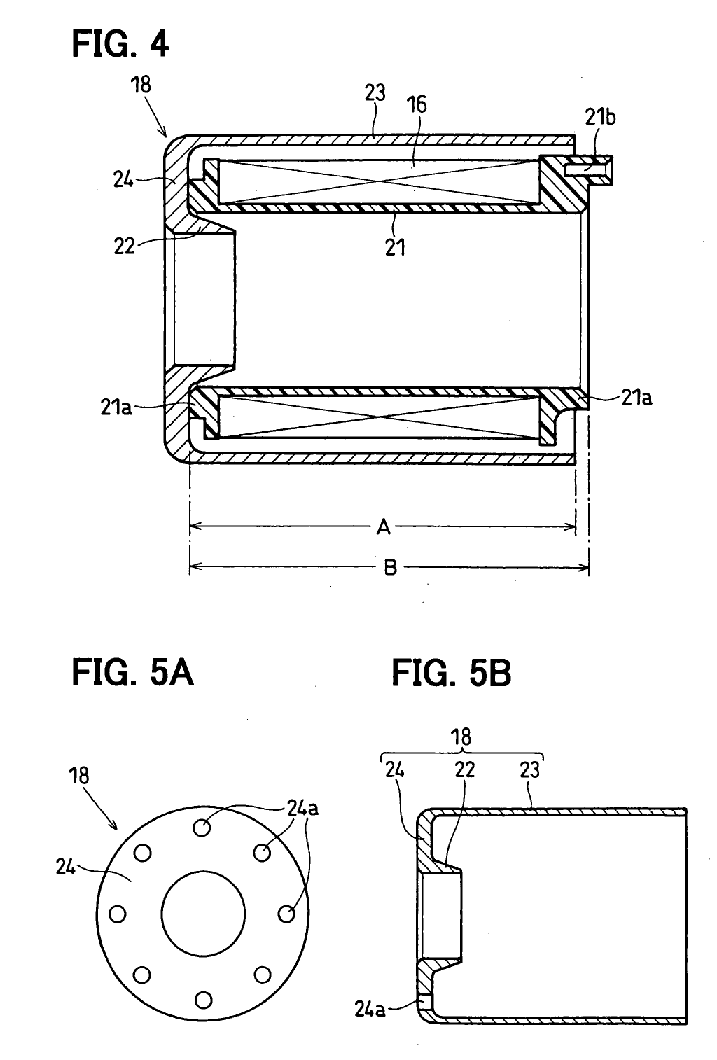

Moreover, in the first embodiment, as shown in FIG. 4, a bobbin accommodation length “A” in the axial direction of the first yoke 23 is formed shorter than the axial length “B” of a bobbin 21. Thereby, as shown in FIG. 3, by pressurizing the front stator 18 and the rear stator 19 in the axial direction, the contact surface of the bobbin 21 and the front stator 18 and the contact surface of the bobbin 21 and the rear stator 19 are pressurized certainly, and the front stator 18 and the rear stator 19 in the condition that the bobbin 21 was accommodated are stuck. Thereby, at the time of molding the secondary molding resin 25, no melted resin leaks from between the bobbin 21 and the stator to the inner circumference side, and no molding resin adheres to the sliding surface of the spool 14 and the plunger 17.

Next, a process of assembling will be explained. First, the sleeve 13 is set in a secondary molding die. Next, the front stator 18 is set in the secondary molding die. Then, the bobbin 21 in which the coil 16 and the terminal 31 are provided is set in the front stator 18. Then, the rear stator 19 is set so that the second yoke 28 may cover the first yoke 23. Then, the stopper 35 is set so that the rear end opening of the rear stator 19 may be blockaded. Then, the sleeve 13 and the stopper 35 are pressurized in the axial direction, and it is filled up with melted resin in the secondary molding die. And after the resin solidifies, the sleeve 13 and the stator which were joined by the solidified secondary molding resin 25 are taken out. Then, the plunger 17 is inserted into the sleeve 13, then spool 14 is inserted into the sleeve 13, the return spring 15 is arranged in the sleeve 13, and a retaining ring 15a is attached to the opening of the sleeve 13, whereby the assembly of the OCV 3 is completed.

### (Description of ECU 4)

An ECU 4 is the well-known computer and is provided with a VVT control function which controls actuation of VVT. An engine operation condition (passenger's condition) is read by the various sensors. Based on signals from the sensor and the VVT control program stored in the memory of ECU 4, a duty ratio control of energization of the coil 16 (the amount of supply current) is performed. The axial position of spool 14 is controlled by controlling the amount of energization of the coil 16. The oil pressure of the advance chamber 7a and the retard chamber 7b is controlled, and the phase angle of the camshaft is controlled according to the engine operation condition.

### (Operation of VVT)

In a case that the camshaft is advanced according to the vehicle driving condition, the ECU 4 increases the amount of supply current to the coil 16. Then, the magnetic force which the coil 16 generates increases and the plunger 17, the shaft 34, and spool 14 move left (advance side) in FIG. 1. Then, while the communicating rate of the hydraulic pressure supply port 13b and the advance port 13c increases, the communicating rate of the retard ports 13d and the drain port 13e increases. As a result, the oil pressure in the advance chamber 7a increases, the oil pressure in the retard chamber 7b decreases conversely, the vane rotor 6 is displaced to the advance side relatively to shoe housing 5, and the camshaft is advanced.

In a case that the camshaft is retarded according to the vehicle driving condition, the ECU 4 decreases the amount of supply current to the coil 16. Then, the magnetic force which the coil 16 generates decreases and the plunger 17, the shaft 34, and spool 14 move right (retard side) in FIG. 1. Then, while the communicating rate of the hydraulic pressure supply port 13b and the retard port 13d increases, the communicating rate of the advance port 13c and the drain port 13e increases. As a result, the oil pressure in the retard chamber 7b increases, the oil pressure in the advance chamber 7a decreases conversely, the vane rotor 6 is displaced to the retard side relatively to shoe housing 5, and the camshaft is retarded.

### Advantage of the First Embodiment

In the OCV 3 of the first embodiment, as mentioned above, the stator of the electromagnetic actuator 12 and the sleeve 13 of the spool valve 11 are joined with the common secondary molding resin 25. Thus, the spool valve 11 and the electromagnetic actuator 12 can be joined, without using the caulking process. That is, the stator and the sleeve 13 can be joined, without a plastic deformation of metal. Hence, a large external force causing deformation does not act on a connecting portion of the sleeve 13 and the stator. The physical relationship of the sleeve 13 and the stator can be kept appropriate even if an external force is applied thereto. And it can prevent a distortion on the OCV3. Thus, since the distortion of the OCV 3 is prevented, the attachment efficiency of the OCV3 to the engine cylinder head does not deteriorate.

Moreover, since the secondary molding resin 25 covers an outer surface of the stator, the outside surface of the stator is not exposed. Hence, it is unnecessary to acquire the corrosion resistance of the stator.

### Second Embodiment

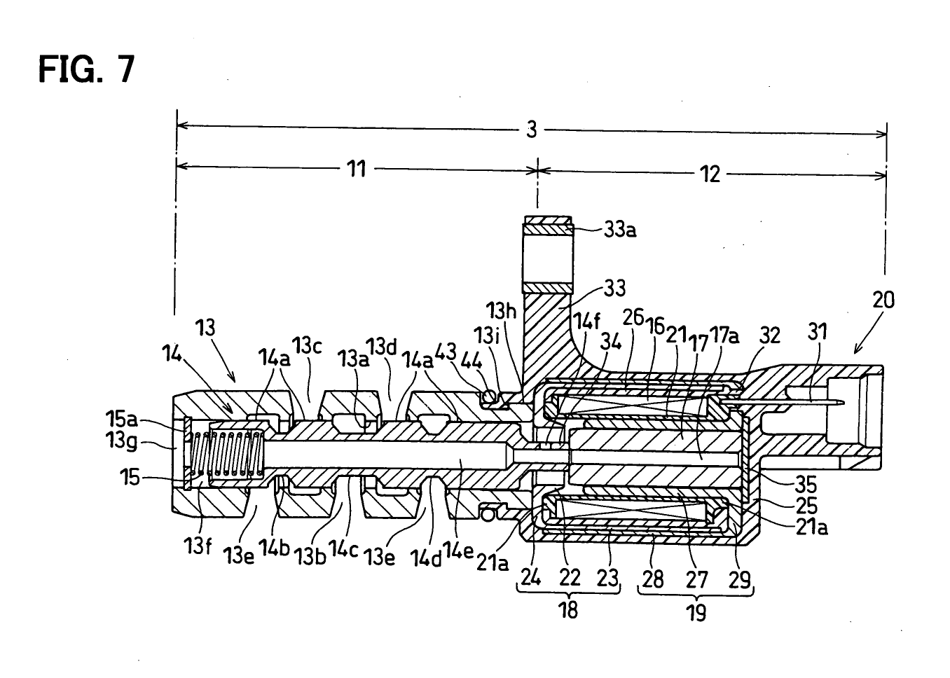

Referring to FIGS. 7-9, a second embodiment will be described hereinafter. In addition, in each following embodiment, the same parts and components as those in the first embodiment are indicated with the same reference numerals. As shown in the above-mentioned first embodiment, the OCV 3 is the electromagnetic spool valve which unified the spool valve 11 and the electromagnetic actuator 12 by the secondary molding resin 25. While the spool valve 11 is inserted in the interior of the insertion hole 42 formed in the fixed objects 41 (engine cylinder head etc.), the electromagnetism actuator 12 is arranged to the exterior of the fixed object 41. When the electromagnetic actuator 12 is arranged inside the engine cylinder head, it is no problem even if the oil inside the insertion hole 42 leaks to the exterior. On the other hand, when the electromagnetic actuator 12 is arranged in the atmospheric air, if the oil inside the insertion hole leaks outside, the problem will arise.

When the electromagnetism actuator 12 is arranged in the atmospheric air, in order to prevent the oil inside the insertion hole 42 from leaking to the electromagnetic actuator 12 side (exterior), the following structure is adopted in the second embodiment.

(1) The secondary molding resin 25 covers whole of the electromagnetic actuators 12 other than the terminal 31 as well as the first embodiment.

(2) The perimeter of the terminal 31 in the bobbin 21 is connected with the secondary molding resin 25 by hot welding. Specifically, around the insertion projection (a part of the bobbin 32 inserted into the terminal hole 32) inserted in the interior of the terminal hole 32 in the rear end of the bobbin 21, a fine protrusion (not shown) covering the perimeter of the insertion projection is formed at the time of forming the bobbin 21. When the melted secondary molding resin 25 is introduced into the interior of the secondary molding die, the fine protrusion is melted into the secondary molding resin 25, so that hot welding of the bobbin 21 and the secondary molding resin 25 may be performed. Since the oil path through which the oil reaches the junction boundaries of the terminal 31 and the molding resin is lost by the above hot welding, no oil leaks from the junction boundaries of the terminal 31 and the molding resin. In addition, the hot welding may be performed also in the part which confronts the secondary molding resin 25 at the front and rear ends of the bobbin 25. For this reason, since the oil does not touch the coil 16, the oil does not flow from the coil 16 to the terminal 31 through a coil end. That is, the oil does not leak from the boundary of the bobbin 21 and the terminal 31 to the exterior.

(3) The secondary molding resin 25 covers the outer circumference of the edge of the sleeve 13 annularly, and performs molding of the sleeve 13.

(4) An overlap resin 25a which covers the outer circumference of the edge of the sleeve 13 is inserted in the interior of the insertion hole 42 formed in the fixed object 41 with the sleeve 13.

(5) An O-ring 43 (a seal ring) is arranged between the insertion hole 42 of the fixed object 41 and overlap resin 25a. The O-ring 43 forms sealing-surface a in the insertion hole 42 and overlap resin 25a, and it prevents the oil in the insertion hole 42 from leaking to the exterior.

(6) With a stepped surface 13j and the overlap resin 25a, a ring groove 44 equipped with O-ring 43 is formed. This ring groove 44 is formed by the molding die at the time of molding the secondary molding resin 25. Since O-ring 43 forms sealing-surface a in contact with overlap resin 25a, a bottom face of the ring groove 44 is formed with overlap resin 25a. Specifically, in order that the diameter (insertion outside diameter to the insertion hole 42) of the sleeve 13 is substantially equal to the diameter (insertion outside diameter to the insertion hole 42) of overlap resin 25a, the diameter of the overlap sleeve 13k arranged inside overlap resin 25a is smaller than that of the sleeve 13. In the second embodiment, the ring groove 44 equipped with O-ring 43 is formed by utilizing the stepped surface 13j, and the bottom face of the ring groove 44 is formed by a part of overlap resin 25a which covers the outer circumference of the overlap sleeve 13k.

### Advantage of the Second Embodiment

In the OCV3 of the second embodiment, as mentioned above, except for the terminal 31 in which the leakage path of the oil is cut off, the secondary molding resin 25 covers all the outsides of the electromagnetic actuator 12. For this reason, the part through which the oil in the electromagnetism actuator 12 can leak is limited to the junction boundaries of the sleeve 13 and the secondary molding resin 25. And overlap resin 25a covers the outer circumference of the edge of the sleeve 13. The O-ring 43 performs the seal between the overlap resin 25a and the insertion holes 42 where the spool valve 11 is inserted. Thereby, the periphery of the junction boundaries of the sleeve 13 and the secondary molding resin 25 can be located in the interior side of the insertion hole 42 (reverse side of atmosphere release side) from the O-ring 43.

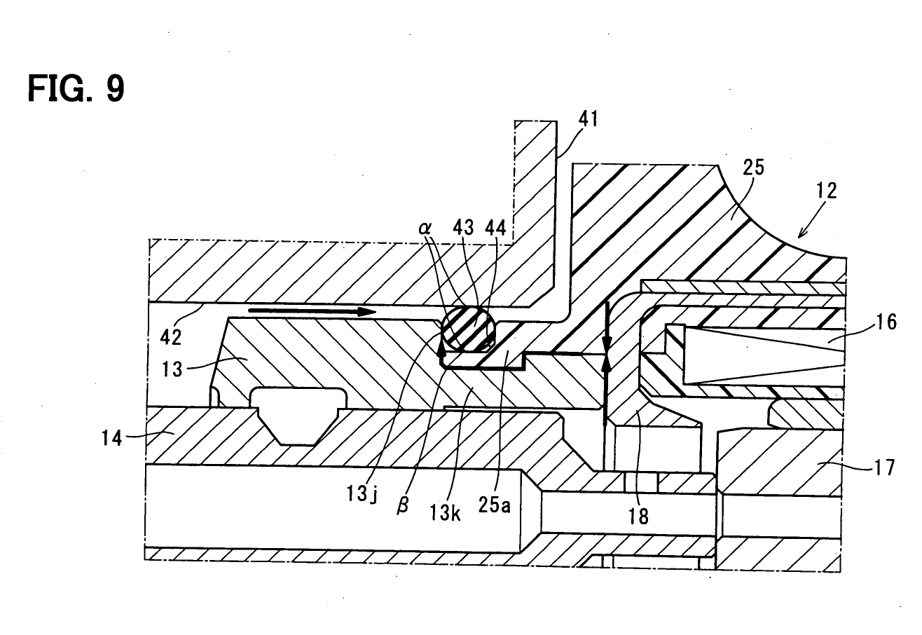

Thereby, as shown by an arrow β in FIG. 9, even if the oil in the spool valve 11 and the electromagnetic actuator 12 leaks to the insertion hole 42 through the junction boundaries of the sleeve 13 and the secondary molding resin 25, the oil leaks inside the insertion hole 42 from the O-ring 43. The oil is prevented from leaking to the exterior by the O-ring 43. As a result, as shown in the second embodiment, even if the electromagnetic actuator 12 is arranged in the atmospheric air, it can prevent the oil leaking to the atmospheric-air side only with one O-ring 43. That is, since the seal part can be lessened, while being able to improve the reliability over oil leakage, the cost can be held down due to the decrease of components and assembling process.

### Third Embodiment

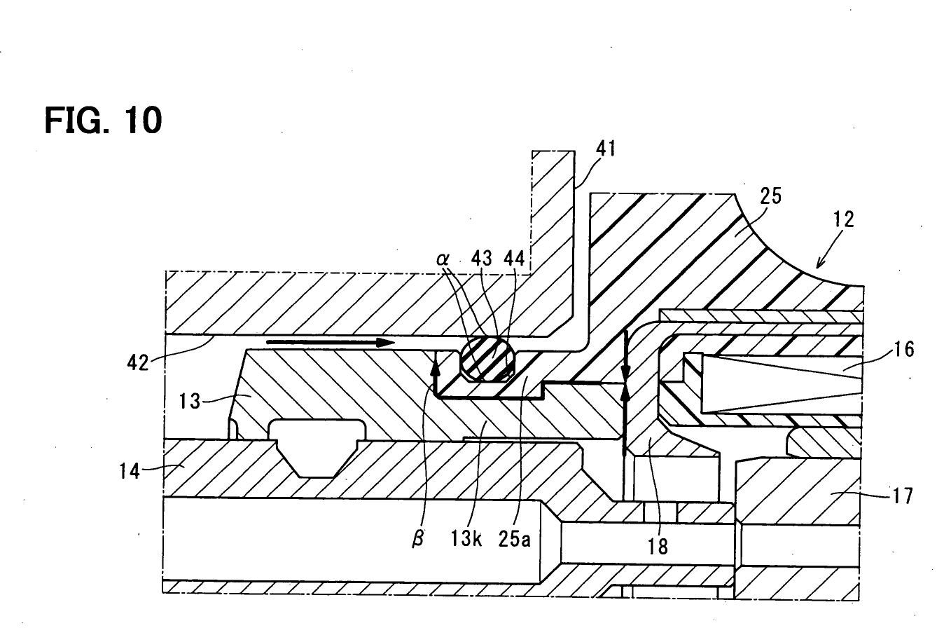

Referring to FIG. 10, a third embodiment is described. In the above-mentioned the second embodiment, the ring groove 44 equipped with the O-ring 43 is formed using the stepped surface 13j of the overlap sleeve 13k. In the third embodiment, the ring groove 44 is formed only by overlap resin 25a. The same advantage as the second embodiment can be obtained.

### Fourth Embodiment

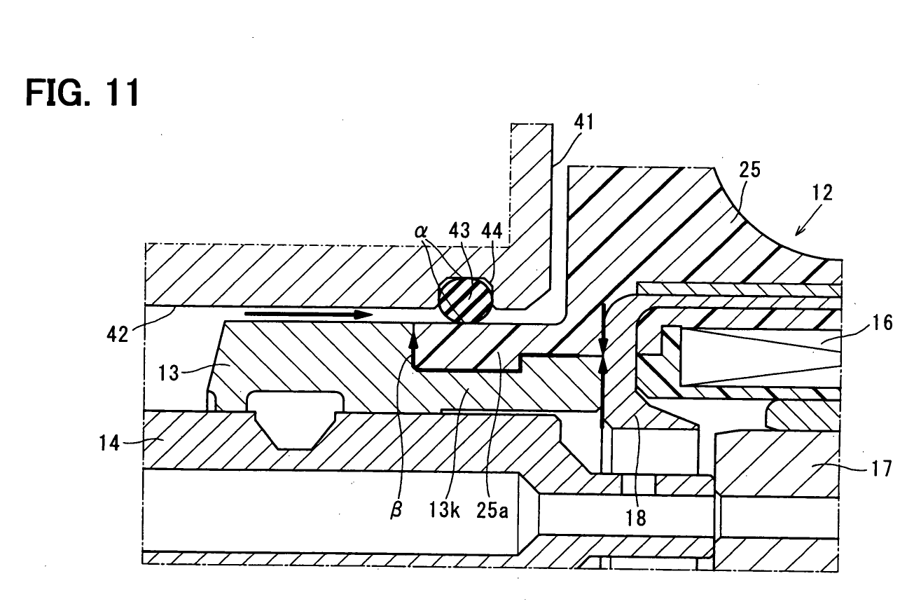

A fourth embodiment is described with reference to FIG. 11. In the above-mentioned embodiments, the ring groove 44 equipped with O-ring 43 is formed in the OCV3. In the fourth embodiment, the ring groove 44 equipped with the O-ring 43 is formed on an inner surface of the insertion hole 42 in the fixed object 41. The same advantage as the second embodiment can be obtained.

### [Modification]

Although the above-mentioned embodiments show the example which applies this invention to the OCV 3 used for VVT, this invention is applied to an OCV (for example, an OCV for the oil pressure control of the automatic transmission etc.) used for the applications other than VVT. Although the above-mentioned embodiments show the example which applies this invention to the electromagnetic spool valve used as the OCV 3, this invention can be applied to the electromagnetic spool valve used for the change of the fluid, a pressure regulation, a flow control other than the oil.

Although the above-mentioned embodiments show the example which drives the spool valve 11 with the electromagnetic actuator 12, this invention can be applied to the electromagnetic actuator which drives the valve device which is different from the spool valve 11. That is, this invention can be applied to the electromagnetic actuator of all the solenoid controlled valves. Furthermore, this invention can be applied to the electromagnetic actuator used for other than the solenoid controlled valve. That is, the actuation object device is not limited to the valve device, and this invention may be applied to various actuation object devices and the electromagnetic actuator.

What is claimed is:

1. An electromagnetic actuator which drives an actuation subject arranged in a housing of an actuation subject device, comprising:
a cylindrical bobbin around which a coil is wound;
a plunger which is magnetically attracted by a magnetic force generated by the coil to drive the actuation subject;
a stator which includes a magnetic attracting portion magnetically attracting the plunger in an axial direction, a yoke surrounding a circumference of the coil, and a magnetically transmitting portion radially transmitting and receiving a magnetic flux from the plunger; and
a molding resin which molds an outer surface of the stator and at least a part of the housing.

2. An electromagnetic actuator according to claim 1, wherein
the molding resin fills up between the coil and the yoke to mold the coil.

3. An electromagnetic actuator according to claim 2, wherein
the stator is provided with a resin inlet through which a melted resin flows into a filling space defined between the coil and the yoke, and
the stator is provided with a through hole through which the melted resin flows from the filling space toward the housing.

4. An electromagnetic actuator according to claim 1, wherein
the housing includes a cylindrical portion on which the molding resin is molded, and
the cylindrical portion is provided with a step of which bottom surface has smaller diameter than the other part of the cylindrical portion.

5. An electromagnetic actuator according to claim 1, wherein
the stator is cylindrical and has an opening end which is in contact with the housing.

6. An electromagnetic actuator according to claim 5, wherein
the stator has the other opening end which is closed by a stopper made of non-magnetic metal.

7. An electromagnetic actuator according to claim 1, wherein
the bobbin has a first end and a second end in its axial direction, which are in contact with the stator.

8. An electromagnetic actuator according to claim 7, wherein
the stator is comprised of a first stator and a second stator, the first stator includes the magnetic attracting portion and a first yoke which is a part of the yoke, the second stator includes the magnetically transmitting portion and a second yoke which is the other part of the yoke, the first yoke and the second yoke have different diameter to be magnetically overlapped with each other, and
one of the first yoke and the second yoke which is arranged inside has a bobbin accommodating length which is smaller than an axial length of the bobbin.

9. An electromagnetic actuator according to claim 1, wherein
the housing is a cylindrical sleeve,
the actuation subject is a spool slidably supported in the sleeve in an axial direction thereof, and
the actuation subject device is a spool valve.

10. An electromagnetic actuator according to claim 9, wherein
the electromagnetism actuator is combined with the spool valve to constitute an electromagnetic spool valve,
the electromagnetic spool valve is structured in such a manner that oil flows into the electromagnetic actuator and the spool valve, the spool is disposed in an insert hole formed on a fixing subject, the electromagnetic actuator is disposed in such a manner as to be exposed in an atmosphere outside of the fixing subject,
the molding resin covers an outer surface of the electromagnetic actuator except a terminal of the coil, and covers an end of the sleeve to mold the sleeve,
an overlap resin of the molding resin which covers the end of the sleeve is inserted into the insert hole with the sleeve, and
a seal ring is provided between the insert hole and the overlap resin to prevent an oil leak from the insert hole.

11. An electromagnetic actuator according to claim 10, wherein
the sleeve and the overlap resin form a ring groove for receiving the seal ring, and
a bottom surface of the ring groove is defined by the overlap resin.
